(19) United States
(12) Patent Application Publication
(10) Pub. No.: US 2026/0003912 A1
(43) Pub. Date: Jan. 1, 2026

(54) SEARCHING METHOD AND APPARATUS, ELECTRONIC DEVICE AND STORAGE MEDIUM

(71) Applicant: Beijing Zitiao Network Technology Co., Ltd., Beijing (CN)

(72) Inventor: Chuwen SHEN, Beijing (CN)

(21) Appl. No.: 18/878,449

(22) PCT Filed: Mar. 12, 2024
(86) PCT No.: PCT/CN2024/081063

§ 371 Date: Dec. 23, 2024

(30) Foreign Application Priority Data
Apr. 27, 2023 (CN) 202310476960.4

(51) Int. Cl. G06F 16/9038; G06F 3/0482; G06F 16/9032; G06F 40/30; H04L 51/02

(52) U.S. Cl. CPC G06F 16/9038; G06F 3/0482; G06F 16/90324; G06F 40/30; H04L 51/02

(57) ABSTRACT

The present disclosure provides a searching method and apparatus, an electronic device and a storage medium. The method includes: receiving an input search term; acquiring a search result corresponding to the search term and a display target page of the search result, wherein the search result is multimedia information which is generated based on a generative model and answers the search term, and the display target page is determined according to at least one attribute characteristic of the search result; and displaying the search result in the display target page.

This application claims the priority of Chinese Patent Application No. 202310476960.4 filed on Apr. 27, 2023, and the disclosure of the above-mentioned Chinese Patent Application is hereby incorporated in its entirety by reference as a part of this application.

### TECHNICAL FIELD

Embodiments of the present disclosure relate to a searching method and apparatus, an electronic device and a storage medium.

### BACKGROUND

At present, users can acquire corresponding search results by entering search terms in search scenarios. However, in related technologies, there are a huge number of search results, and users often need to check multiple search results to satisfy their requirements or need to search for a second time, which costs a longer time and reduces the search efficiency.

### SUMMARY

The embodiments of the present disclosure at least provide a searching method and apparatus, an electronic device and a storage medium.

In a first aspect, an embodiment of the present disclosure provides a searching method, including:
receiving an input search term;
acquiring a search result corresponding to the search term and a display target page of the search result, where the search result is multimedia information which is generated based on a generative model and answers the search term, and the display target page is determined according to at least one attribute characteristic of the search result; and
displaying the search result in the display target page.

In a second aspect, an embodiment of the present disclosure further provides a searching apparatus, including:
a receiving module, configured to receive an input search term;
an acquisition module, configured to acquire a search result corresponding to the search term and a display target page of the search result, where the search result is multimedia information which is generated based on a generative model and answers the search term, and the display target page is determined according to at least one attribute characteristic of the search result; and
a first display module, configured to display the search result in the display target page.

In a third aspect, an alternative implementation of the present disclosure further provides an electronic device, including a processor and a memory, where the memory stores machine-readable instructions executable by the processor, and the processor is configured to execute the machine-readable instructions stored in the memory, and when the machine-readable instructions are executed by the processor, the processor executes the steps in the first aspect or any possible implementation of the first aspect.

In a fourth aspect, an alternative implementation of the present disclosure further provides a computer-readable storage medium on which a computer program is stored, where the computer program, when executed by a processor, executes the steps in the first aspect or any possible implementation of the first aspect.

For the description of the effects of the above-described searching apparatus, electronic device and computer-readable storage medium, reference can be made to the description of the above-described searching method, which is not repeated here.

It should be understood that both the above general description and the following detailed description are exemplary and explanatory only, and are not intended to limit the technical solution of the present disclosure.

In order to make the above objectives, features and advantages of the present disclosure more obvious and easier to understand, the following is a detailed description of preferred embodiments in conjunction with accompanying drawings.

### BRIEF DESCRIPTION OF DRAWINGS

In order to explain the technical solution of the embodiments of the present disclosure more clearly, the drawings required to be used in the embodiments, that are incorporated into and constitute a part of this specification, will be briefly introduced below. These drawings illustrate the embodiments in accordance with the present disclosure, and together with the specification, serve to explain the technical solution of the present disclosure. It should be understood that the following drawings only illustrate some embodiments of the present disclosure, and should not be regarded as any limitation to the scope thereof. For those ordinary skilled in the art, other related drawings can be obtained, without any creative work, according to these drawings.

FIG. 1 shows a flowchart of a searching method provided by an embodiment of the present disclosure;

FIG. 2 shows a schematic diagram of an interface for a chat page associated with a generative model provided by an embodiment of the present disclosure;

FIG. 3 shows a schematic diagram of an interface for displaying a jumping access of a generative model provided by an embodiment of the present disclosure;

FIG. 4 shows a schematic diagram of an interface for displaying a search result in a search prompt page provided by an embodiment of the present disclosure;

FIG. 5 shows a schematic diagram of an interface for displaying a search result in a search result page provided by an embodiment of the present disclosure;

FIG. 6 shows a schematic diagram of an interface for displaying a recommended search term in a search interstitial page provided by an embodiment of the present disclosure;

FIG. 7 shows a schematic diagram of an interface for displaying a recommended search term in a search result page provided by an embodiment of the present disclosure;

FIG. 8 shows a schematic structural diagram of a searching apparatus provided by an embodiment of the present disclosure; and

FIG. 9 shows a schematic diagram of an electronic device provided by an embodiment of the present disclosure.

### DETAILED DESCRIPTION

It should be understood that prior to using the technical solution disclosed in various embodiments of the present disclosure, users should be informed of the type, scope of usage, usage scenarios, etc. of personal information involved in the present disclosure in an appropriate way in accordance with relevant laws and regulations and be authorized by the users.

In order to make the purpose, technical solutions and advantages of the embodiments of the present disclosure more definite, the technical solutions in the embodiments of the present disclosure will be described clearly and completely in conjunction with the accompanying drawings. Obviously, the described embodiments are only part of but not all of the embodiments of the present disclosure. Components of embodiments of the present disclosure generally described and illustrated herein may be arranged and designed in various different configurations. Therefore, the following detailed description of the embodiments of the present disclosure is not intended to limit the scope of the claimed disclosure, but merely represents selected embodiments of the present disclosure. Based on the embodiments of the present disclosure, all other embodiments obtained by those skilled in the art without creative work belong to the scope of protection of the present disclosure.

It is found during research that, in related technologies, there are a huge number of search results, and users often need to check multiple search results to satisfy their requirements or need to search for a second time, which costs a longer time and reduces the search efficiency.

Based on the above research, the present disclosure provides a searching method, which uses multimedia information, that is generated for a search term based on a generative model and answers the search term, as a search result corresponding to the search term, and determines a display target page according to at least one attribute characteristic of the search result, so that the search result can be displayed in the display target page. In this way, the search results are generated based on the generative model, which improves the quality and performance of the search results; and the search results can be displayed in different display target pages based on the attribute characteristics of the search results, which increases the flexibility and diversity of the display of the search results generated by the generative model and is more in line with the search requirements, thereby improving the efficiency of viewing the search results by users and enhancing the users' experience during searching.

The shortcomings to be alleviated by the above-described solution are the results obtained by the inventor(s) after practice and careful study. Therefore, the discovery process of the above problems and the solutions proposed in the present disclosure as below should be the contributions made by the inventor(s) to the present disclosure in the process of the present disclosure.

It should be noted that similar symbols and letters indicate similar items in the following drawings. Accordingly, once an item is defined in one drawing, it does not need to be further defined and explained in subsequent drawings.

In order to facilitate the understanding of this embodiment, firstly, a searching method disclosed in this embodiment of the present disclosure is introduced in details. The execution subject of the searching method provided in this embodiment of the present disclosure is generally an electronic device with certain computing power, which includes, for example, a terminal device or a server or other processing devices. The terminal device can be a user equipment (UE), a mobile device, a cellular phone, a cordless phone, a personal digital assistant (PDA), a handheld device, a computing device, a vehicle-mounted device, a wearable device, etc. Among them, the personal digital assistant is a handheld electronic device with some functions of electronic computers, which can be used to manage personal information, surf the Internet, send and receive emails, etc. Generally, the personal digital assistant is not equipped with a keyboard, and can also be referred to as a palmtop computer. In some possible implementations, the searching method can be realized by a processor invoking computer-readable instructions stored in a memory.

Hereinafter, the searching method provided by the embodiment of the present disclosure will be explained with reference to the case where the execution subject is a terminal device, by way of example.

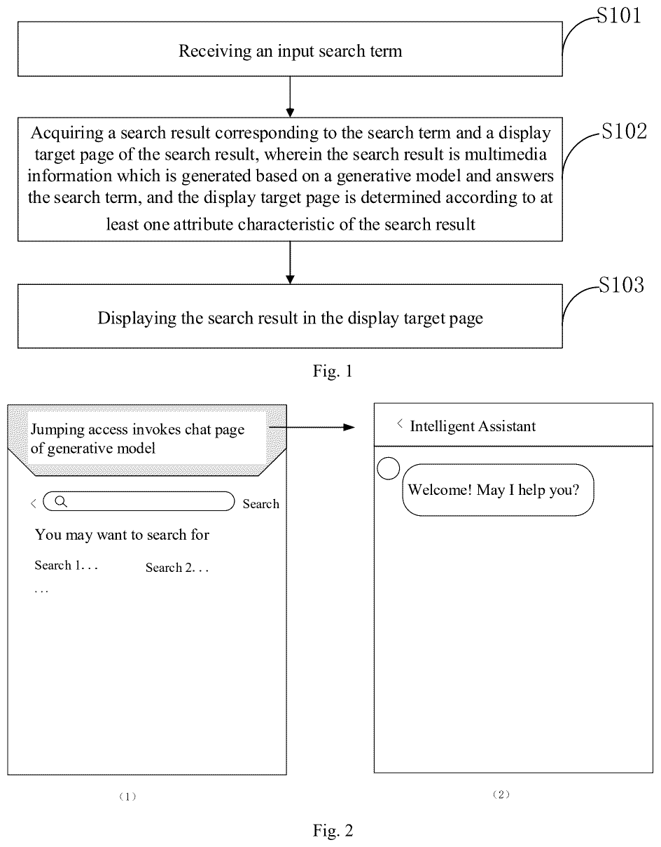

Referring to FIG. 1, it is a flowchart of a searching method provided by an embodiment of the present disclosure, which includes the following steps.
S101, receiving an input search term.

In the embodiment of the present disclosure, for any search scenario or question-and-answer dialogue scenario or the like, a user can input a search term to be searched or questioned. Based on different application scenarios, the user can input a search term in different accesses, for example, inputting the search term in a search box, and for another example, inputting the search term in a chat interface, which is not limited in the embodiment of the present disclosure.

Furthermore, it's not intended to limit the input mode of the search term, for example, a manual input through an input method, or a voice input.

S102, acquiring a search result corresponding to the search term and a display target page of the search result, where the search result is multimedia information which is generated based on a generative model and answers the search term, and the display target page is determined according to at least one attribute characteristic of the search result.

Among them, a generative model representation is to model the joint probability distribution of characteristics and tags, and can be trained based on different training samples to be applied to different scenarios. In the embodiment of the present disclosure, the trained generative model is a conversational large-scale language model, which can generate more intelligent, more anthropomorphic and high-quality search results or answers by integrating different types of resources.

In the embodiment of the present disclosure, a display target page can also be determined

according to at least one attribute characteristic of the search result, for example, the display target page is a search prompt page and a search result page, and different display target pages can provide different display effects, thereby improving the search experience.

S103, displaying the search result in the display target page.

In the embodiment of the present disclosure, the same or different display modes can be adopted in different display target pages to be adapted to the display target pages.

When this step S103 is executed, the present disclosure provides a possible implementation which displays the search result in the display target page, including: displaying the search result in a line-by-line display mode in the form of a display card, in the search result page of the search term. In the line-by-line display mode, a time interval for displaying each line is related to a time for generating each line of information of the search result by the generative model.

The search results can be displayed, in the form of a display card, in the search result page. The generative model generates the search results in a way different from the traditional search engine which retrieves and sorts, and it usually takes a certain time to generate the search results by the generative model. Therefore, it is unnecessary to wait until all the search results are generated before displaying the search results, to avoid the bad experience for the users caused by the long-time waiting of the users. In the embodiment of the present disclosure, a part of the search results can be displayed in real time when it's generated by the generative model. The search results are displayed line by line, and the time interval for displaying each line is related to the time or speed for generating each line of information by the generative model. For example, it is preferable that the time interval for displaying is greater than or equal to the time for generating each line of information of the search results by the generative model, so that the search efficiency can be improved and the waiting time can be reduced.

Further, when displaying the search results in the display target page, in order to improve the cognitive sense of the generative model and to distinguish the generative model from the traditional search engine, an embodiment of the present disclosure further provides a possible implementation, including: displaying a source of the search result as the generative model; and/or displaying a preset identifier representing the generative model.

In the embodiment of the present disclosure, in order to further improve the search efficiency, a recommended search term can also be displayed. Specifically, the present disclosure provides a possible implementation, including: displaying a recommended search term card in a search interstitial page or a search result page of the search term. Among them, the recommended search term in the recommended search term card is generated based on the generative model according to a preset determinant factor. The preset determinant factor includes at least one of the following: a historical search behavior, a historical browsing behavior, a quality evaluation degree of the search result corresponding to the recommended search term, and feedback information of a target object.

For example, a user plays a small video in a small video application program, and then has a search requirement. If the user wants to search for something, he/she can trigger a search function in the small video application program and enter a search interstitial page. At this time, the recommended search term can be displayed in the search interstitial page, for example, the recommended search term can be related to the content in the small video just played, which can improve the search efficiency.

For another example, after a user enters a search term for searching, the search result is displayed in a search result page, and the recommended search term is also displayed in the search result page. It also supports the input of feedback information for the recommended search term, such as “irrelevant”, “erroneous”, “relevant”, etc., to continuously update the recommended search term corresponding to the search term and improve the accuracy.

Of course, in the embodiment of the present disclosure, it's not intended to limit the determinant factor of the recommended search term; and when the recommended search term card is displayed, the source of the recommended search term can be displayed as a generative model and/or a preset identifier representing the generative model.

Also, it's not intended to limit the display style of the recommended search term, for example, it's not only in the form of recommended search term card, but also in other ways.

In the embodiment of the present disclosure, an input search term is received, and a search result corresponding to the search term and a display target page of the search result are acquired, where the search result is multimedia information which is generated based on a generative model and answers the search term, and the display target page is determined according to at least one attribute characteristic of the search result, and then the search result is displayed in the display target page. In this way, the search result is generated based on the generative model, and the display target page is determined according to the attribute characteristic of the search result, so that the display target page is more in line with the display requirements of the search result, which can improve the display effect of the search result, thereby improving the efficiency of viewing the search results by users and enhancing the users' experience during searching.

For the above step S102, in the embodiment of the present disclosure, after receiving the search term, the search result corresponding to the search term and the display target page are determined, which will be explained below separately.

Part I: For the display target page

The embodiment of the present disclosure provides a possible implementation of determining the display target page. Specifically, determining the display target page of the search result according to the attribute characteristic corresponding to the search result, where the attribute characteristic includes at least one of the following: a size of a display area as required, a number of the display result, and a type of multimedia content contained in the multimedia information.

Based on different conditions satisfied by the attribute characteristic, different display target pages can be determined correspondingly.

(I) In a possible embodiment, determining the display target page of the search result according to the attribute characteristic corresponding to the search result, including: determining the display target page of the search result as a search prompt page of the search term in response to a first condition being satisfied, where the search prompt page represents a page containing a prompt box of a search box.

Among them, the first condition includes: the size of the display area as required by the search result does not exceed a preset size or a display proportion of the size of the display area as required does not exceed a preset proportion, and the number of the search result is one, where one search result is able to answer the search term, and the one search result includes information which does not exceed a preset number of lines.

In the embodiment of the present disclosure, for some search terms in the type of copywriting, for example, the generative model may only need to generate one search result, or, one of the search results is enough to answer the search term. For example, the search term is “Copywriting for describing moonlight”, the generative model can generate the search result correspondingly through semantic analysis of the search term, and one search result is enough to answer the search term. Furthermore, a prompt box needs to be expanded below a search box in the search prompt page, and multiple recommended words displayed in the prompt box must occupy a certain area; as a result, when displaying the search result in the search prompt page, the search result should satisfy the size of the display area as required or the display proportion should not be too large, to avoid affecting the display of the recommended words in the prompt box. In this way, after the user inputs the search term, the search result as required can be known from the search prompt page, which reduces the steps of search operation and improves the search efficiency.

Further, after the search result is displayed in the search prompt page, if the user needs a search result which is more diverse, he/she can click for searching, again, to be jumped to the search result page, so that more and wider variety of search results can be displayed in the search result page to satisfy different search requirements of users.

(II) In another possible embodiment, determining the display target page of the search result according to the attribute characteristic corresponding to the search result, including: determining the display target page of the search result as a search result page of the search term in response to a second condition being satisfied.

Among them, the second condition includes at least one of the following: the size of the display area as required by the search result exceeds the preset size or the display proportion of the size of the display area as required exceeds the preset proportion, and the number of the search result is greater than one, where at least two search results are required to be able to answer the search term, or the corresponding search result that is able to answer the search term includes information which exceeds a preset number of lines.

In this embodiment, considering the characteristics of the search prompt page, some search results requiring for display areas with larger size or larger display proportion will have poor display effects in the search prompt page, and can be displayed in the search result page. For example, for some search terms with vague intentions, there will be multiple search results as generated; after the user inputs a search term and clicks for searching, it can be jumped to the search result page and the search results can be displayed in the search result page.

Part II: Displaying the search result

For the determination of the search result, the embodiment of the present disclosure provides a possible implementation including the following steps.

(I) Determining a search intention of the search term.

For example, inputting the search term into the generative model, identifying an intention of the search term, and determining the search intention of the search term.

(II) Determining, according to the search intention, a working state of the generative model when generating the search result, where the working state is an offline state or an online state.

Specifically, if it is determined that the search intention indicates there is an intention to rely on factual requirement and/or timeliness requirement when answering the search term, determining the working state of the generative model when generating the search result as the online state; if it is determined that the search intention indicates there is no intention to rely on factual requirement and/or timeliness requirement when answering the search term, determining the working state of the generative model when generating the search result as the offline state.

For example, if the search term is “Write a 300-word primary school composition”, the search intention of the search term is determined as the type of content creation, which does not need to rely on facts and timeliness but can be fictional, i.e., anything that is related to the subject. In such case, the generative model can generate corresponding search results in an offline state without networking, which improves efficiency.

(III) Generating the search result corresponding to the search term based on the generative model in the working state.

Specifically, in a possible implementation, when the working state is the offline state, performing semantic analysis on the search term based on the generative model to generate the search result.

Among them, the generative model can be trained in advance, and after the search term is input into the trained generative model, the generative model can generate the corresponding search result.

In another possible embodiment, when the working state is the online state, acquiring a preset number of top-ranked initial search results which are matching the search term and sorted according to relevant degree; performing semantic analysis on the preset number of top-ranked initial search results based on the generative model by using the preset number of top-ranked initial search results as input parameters, to acquire the search result corresponding to search term.

In the embodiment of the present disclosure, for a search term that depends on factual requirements and timeliness requirements, for example, if the search term is “The weather in the last 15 days”, the generative model needs to be networked to request for invoking a search engine, and the search engine conducts a search to acquire a matching, initial search result; then the initial search result is input into the generative model, and the generative model performs semantic analysis according to the initial search result, thereby generating the final search result.

In addition, in the embodiment of the present disclosure, a jumping access of the generative model can be provided to enter a chat page of the generative model. Specifically, the present disclosure provides a possible implementation: (I) displaying a jumping access for the generative model and receiving a click-on operation for the jumping access; or, receiving a click-on operation for the search result or the recommended search term; (II) jumping to display a chat page associated with the generative model; (III) receiving a chat content input in the chat page; (IV) returning reply information for the chat content, where the reply information is generated by the generative model.

Among them, for the jumping access of the generative model, the present disclosure provides several possible implementations as below.

In a possible implementation, receiving a drop-down operation for the search interstitial page, and displaying the jumping access for the generative model.

For example, referring to FIG. 2, which is a schematic diagram of an interface of a chat page associated with the generative model in the embodiment of the present disclosure. As shown in (1) of FIG. 2, the user can drop down the search interstitial page, and in response to the drop-down operation, a drop-down second-level area of the search interstitial page, that is, a gray area in (1) of FIG. 2, is displayed, and the jumping access of the generative model is displayed in the drop-down second-level area; then the user clicks on the jumping access, that is, jumping to the chat page associated with the generative model, as shown in (2) of FIG. 2. After entering the chat page, greeting information generated by the generative model can be displayed, and information such as the name and avatar corresponding to the generative model can also be set. For example, in FIG. 2, the name corresponding to the generative model is “Intelligent Assistant”, and the avatar is a round shape, so that users can input chat content as needed, and the generative model can return reply information for the chat content in real time, thus achieving the effect of chatting with the generative model; in this way, the generative model can chat with users in a more intelligent and personified manner.

In another possible embodiment, the search result and the recommended search term in the embodiment of the present disclosure are generated based on the generative model, and the jumping access can be displayed in the search result and the recommended search term generated by the generative model. For example, an operation control such as “Chat” and “Ask Questions” representing the jumping access is displayed in the search result or the recommended search term, and it can be jumped to the chat page associated with the generative model after the user clicks on the operation control.

In another possible implementation, in the embodiment of the present disclosure, it can also be jumped to the chat page associated with the generative model by clicking on the search result or the recommended search term. For example, after jumping to the chat page, all the contents of the search result or the recommended search term can be displayed in the chat page, and then other chat contents can be input in the chat page to acquire more information.

In another possible embodiment, a preset floating button is displayed, which represents a jumping access for the generative model.

In the embodiment of the present disclosure, a floating button representing the jumping access of the generative model can also be displayed, and it can be jumped to the chat page associated with the generative model by a user clicking on the floating button. The shape of the floating button is not limited, and may be, for example, circular shape, square shape or other designed logos. The display page of the floating button and the display position of the floating button in the display page are both not limited; for example, it can be displayed in an input page of the search term, a search interstitial page, or a display target page of the search result, etc.; for another example, when the display page is displayed, it can be fixed at a certain position on the display page, or it may have a display position dynamically adjusted according to the content of the display page, to avoid the influence on the display of other contents in the display page.

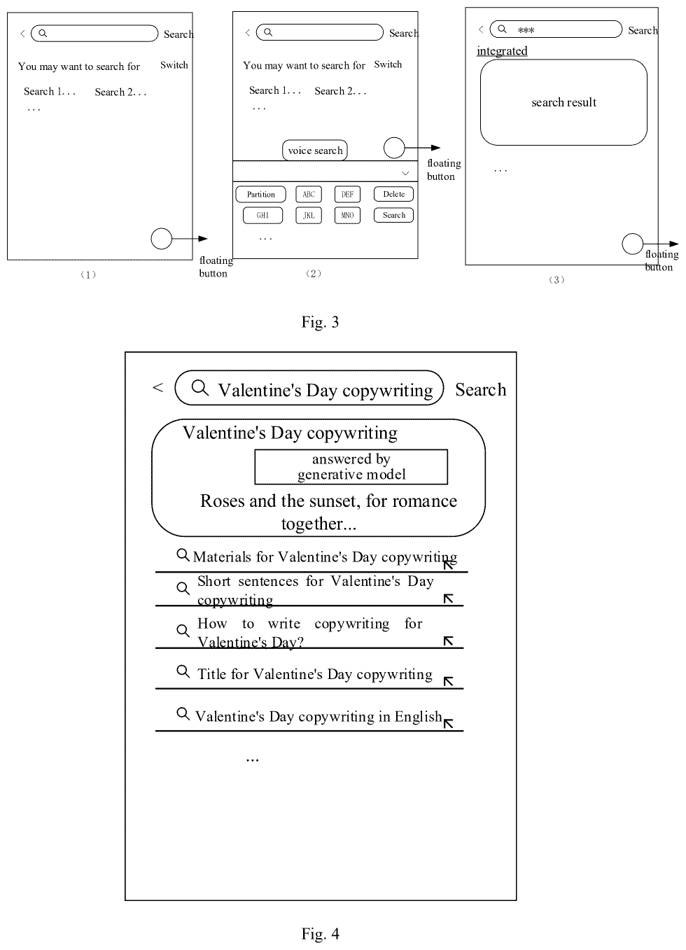

For example, as shown in FIG. 3, it is a schematic diagram of an interface for displaying a jumping access of the generative model in the embodiment of the present disclosure. For example, as shown in (1) of FIG. 3, the floating button of the jumping access of the generative model is displayed at a certain display position in the search interstitial page, such as the lower right corner. For another example, as shown in (2) of FIG. 3, after the keyboard is invoked in the search interstitial page, the display position of the floating button can be dynamically adjusted. For yet another example, as shown in (3) of FIG. 3, after a click for searching, the floating button can also be displayed in the search result page. That is to say, the floating button can be displayed in all the scenarios during searching, which is not limited in the embodiment of the present disclosure. Then, the user can click on the floating button to be jumped to the chat page of the generative model.

In the embodiment of the present disclosure, other ways or locations can also be used for displaying the jumping access of the generative model, which is not limited here.

In this way, in the embodiment of the present disclosure, the jumping access for the generative model can be displayed at different locations of the search scenarios, and the chat page associated with the generative model can be displayed by jumping so as to realize chatting, which improves the diversity and cognitive sense of the access of the generative model, and enhances the user experience.

It should be understood by those skilled in the art that in the above-mentioned method of specific embodiments, the writing order of various steps does not mean strict execution order or constitute any limitation on the implementation process, and the specific execution order of various steps should be determined according to their functions and possible internal logics.

Hereinafter, the searching method of the embodiment of the present disclosure will be described with specific application scenarios, in which the display target page is a search result page or a search prompt page, by way of example.

Referring to FIG. 4, which is a schematic diagram of an interface for displaying the search result in a search prompt page in the embodiment of the present disclosure. As shown in FIG. 4, a search term, such as “Valentine's day copywriting”, is input into the search box; then the server receives the search term, carries out semantic analysis on the search term based on the generative model and generates the corresponding search result; if it is determined that the search result satisfies the first condition, for example, if there is only one search result and the display area as required has a smaller size or the display proportion of the size of the display area as required is small, for example, if only a few lines are needed in the search result, the display target page can be determined as a search prompt page, and the search result can be displayed in the search prompt page. For example, as shown in FIG. 4, the search result that “Valentine's Day copywriting: roses and sunset, for romance” is displayed below the search box at first, a prompt box is further displayed below the search result, and multiple prompt words for the search term are displayed in the prompt box.

In this way, in the embodiment of the present disclosure, after the user inputs the search term, the required search result can be displayed in the search prompt page, so that the steps and processes for the search operation are reduced and the efficiency is improved.

Moreover, in the embodiment of the present disclosure, when displaying the search result, the source of the search result can also be displayed as a generative model and/or a preset identifier representing the generative model, as shown in FIG. 4. In a possible example, the search result is displayed with “Answer from generative model”, so that users can know the search result was generated by the model, and both the cognitive sense of the generative model and the user experience can be improved.

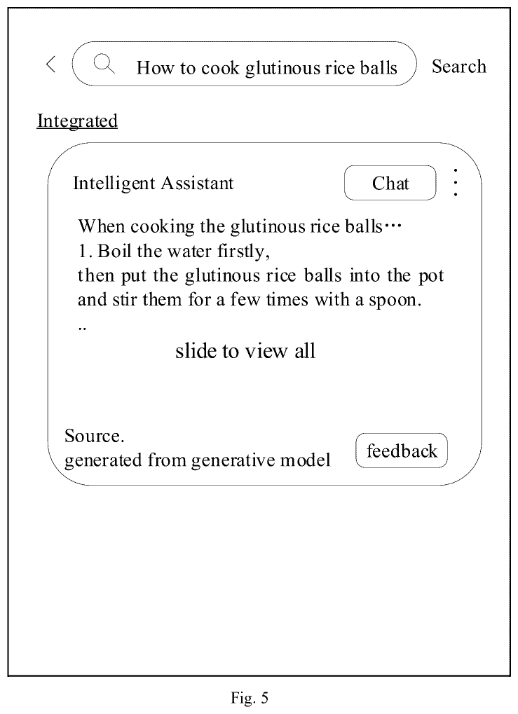

Referring to FIG. 5, it is a schematic diagram of an interface for displaying the search result in a search result page in the embodiment of the present disclosure. For example, the search term is “How to cook glutinous rice balls”. After the user inputs the search term, the search term is semantically analyzed based on the generative model to generate the corresponding search result. If it is determined that the search result satisfies the second condition, that is, for example, if the size of the display area as required by the search result exceeds the preset size or the display proportion of the size of the display area as required exceeds the preset proportion, and for another example, if the number of the search result is more than one, the display target page is determined as a search result page. At this time, the search result will not be displayed in the search prompt page. Then, after a click-on operation by the user for searching, it will be jumped to the search result page of the search term, as shown in FIG. 5, and the search result will be displayed in a line-by-line display mode in the form of a display card in the search result page. In addition, the user can also view all the contents of the search result by sliding; or, for example, the user can view all the contents of the search result by clicking.

In addition, as shown in FIG. 5, the search result is also displayed with “Source. generated from generative model”, which is convenient for users to know the source of the search result. The search result also provides a jumping access for the generative model, such as “Chat” shown in FIG. 5, which is the jumping access for the generative model. When users click on “Chat”, it can be jumped to display the chat page associated with the generative model, and then users can chat with the generative model in the chat page.

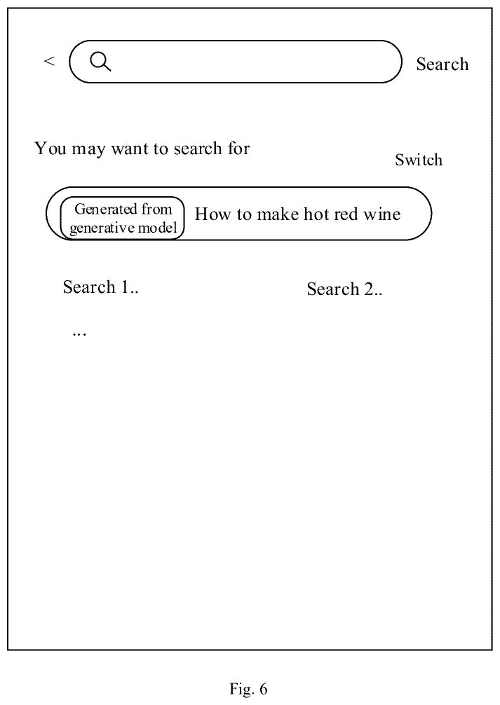

In addition, the embodiment of the present disclosure also supports the display of the recommended search term, as shown in FIG. 6, which is a schematic diagram of an interface for displaying the recommended search term in the search interstitial page in this embodiment of the present disclosure. As shown in FIG. 6, when the user opens the search interstitial page by triggering and has not input the search term in the search box yet, the recommended search term card can be displayed in the search interstitial page, and the recommended search term is displayed in the recommended search term card. As shown in FIG. 6, the recommended search term “How to make hot red wine” is displayed below “You may want to search for”; the user can also be supported to switch the recommended search term by, for example, clicking on “Switch/switching”, so as to be switched to other recommended search terms.

Moreover, as shown in FIG. 6, the recommended search term card can also display the source as a generative model and/or display a preset identifier representing the generative model.

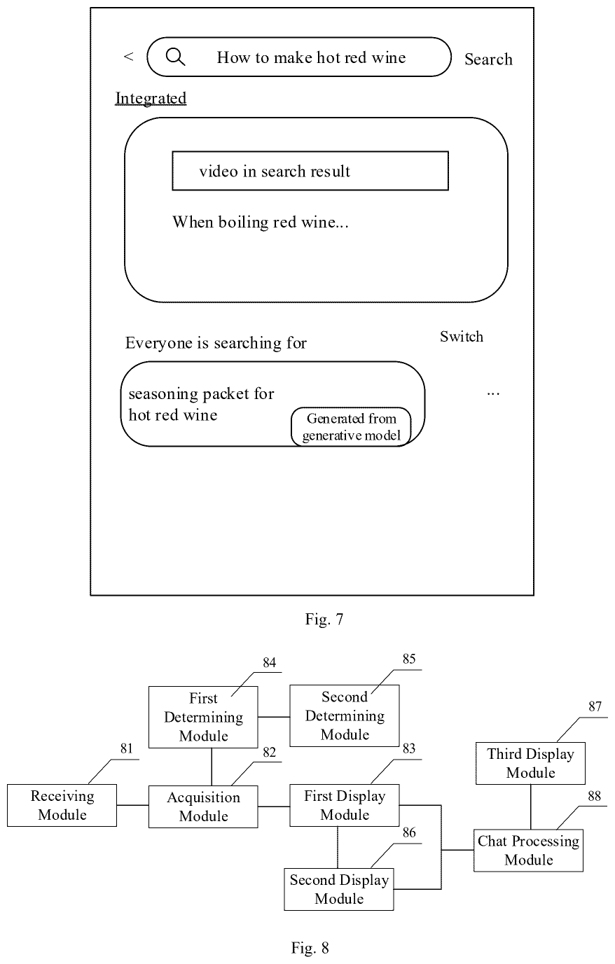

Referring to FIG. 7, which is a schematic diagram of an interface for displaying the recommended search term in the search result page in the embodiment of the present disclosure. For example, a user can click on the recommended search term “How to make hot red wine” to be jumped to the search result page, in which the corresponding search result and the recommended search term are displayed. As shown in FIG. 7, “Everyone is searching for: seasoning packet for hot red wine” and the like are displayed below the first search result, and the source can also be displayed as a generative model and/or a preset identifier representing the generative model.

Among them, the recommended search term can be determined according to historical search behaviors, historical browsing behaviors, quality evaluation degrees of search results corresponding to the recommended search terms, feedback information, etc., and can also be related to the contents in the search results as displayed, which can improve the accuracy of the recommended search terms and satisfy the search requirements of users in a better way.

In the embodiment of the present disclosure, the search result can be displayed in different display target pages according to the attribute characteristic of the search result, so as to improve the display effect of the search result, facilitate users to check the result, and improve the search efficiency; furthermore, the recommended search term can also be displayed so as to satisfy different search requirements of users, and improve the search experience and search efficiency of users.

It should be noted that the schematic diagrams of interfaces in the embodiments of the present disclosure are only possible examples, and the searching method in the embodiments of the present disclosure should not be limited thereto.

Based on the same inventive concept, the embodiment of the present disclosure also provides a searching apparatus corresponding to the searching method. Since the principle of solving problems by the searching apparatus in the embodiment of the present disclosure is similar to the above-mentioned searching method in the embodiment of the present disclosure, the implementation of the apparatus can refer to the implementation of the method and will not be repeated here.

Referring to FIG. 8, which is a schematic structural diagram of a searching apparatus provided by an embodiment of the present disclosure, including:
a receiving module 81, configured to receive an input search term;
an acquisition module 82, configured to acquire a search result corresponding to the search term and a display target page of the search result, where the search result is multimedia information which is generated based on a generative model and answers the search term, and the display target page is determined according to at least one attribute characteristic of the search result; and
a first display module 83, configured to display the search result in the display target page.

An alternative embodiment further includes a first determining module 84, where the display target page is determined by the first determining module 84 through the following steps:
determining the display target page of the search result according to the attribute characteristic corresponding to the search result, where the attribute characteristic includes at least one of the following: a size of a display area as required, a number of the display result, and a type of multimedia content contained in the multimedia information.

In an alternative embodiment, when determining the display target page of the search result according to the attribute characteristic corresponding to the search result, the first determining module 84 is configured to:
determine the display target page of the search result as a search prompt page of the search term in response to a first condition being satisfied, where the search prompt page represents a page containing a prompt box of a search box;
the first condition includes: the size of the display area as required by the search result does not exceed a preset size or a display proportion of the size of the display area as required does not exceed a preset proportion, and the number of the search result is one, where one search result is able to answer the search term, and the one search result includes information which does not exceed a preset number of lines.

In an alternative embodiment, when determining the display target page of the search result according to the attribute characteristic corresponding to the search result, the first determining module 84 is configured to:
determine the display target page of the search result as a search result page of the search term in response to a second condition being satisfied;
the second condition includes at least one of the following: the size of the display area as required by the search result exceeds a preset size or a display proportion of the size of the display area as required exceeds a preset proportion, and the number of the search result is greater than one, where at least two search results are required to be able to answer the search term, or the search result that corresponds to the search term and is able to answer the search term includes information exceeding the preset number of lines.

In an alternative embodiment, when displaying the search result in the display target page, the first display module 83 is configured to display the search result in a line-by-line display mode in the form of a display card in the search result page of the search term, where in the line-by-line display mode, a time interval for displaying each line is related to a time for generating each line of information of the search result by the generative model.

An alternative embodiment further includes a second determining module 85, and the search result is determined by the second determining module 85 in the following way:
determining a search intention of the search term;
determining, according to the search intention, a working state of the generative model when generating the search result, where the working state is an offline state or an online state; and
generating the search result corresponding to the search term based on the generative model in the working state.

In an alternative embodiment, when generating the search result corresponding to the search term based on the generative model in the working state, the second determining module 85 is configured to:
acquire a preset number of top-ranked initial search results which are matching the search term and sorted according to relevant degree, in response to the working state being the online state; and
perform semantic analysis on the preset number of top-ranked initial search results based on the generative model by using the preset number of top-ranked initial search results as input parameters, to acquire the search result corresponding to the search term.

An alternative embodiment further includes a second display module 86, configured to display a recommended search term card in a search interstitial page or a search result page of the search term;
a recommended search term in the recommended search term card is generated based on the generative model according to a preset determinant factor, and the preset determinant factor includes at least one of the following: a historical search behavior, a historical browsing behavior, a quality evaluation degree of the search result corresponding to the recommended search term, and feedback information of a target object.

An alternative embodiment further includes a third display module 87, configured to receive a drop-down operation for the search interstitial page and display a jumping access for the generative model.

In an alternative embodiment, the first display module 83 is further configured to:
display a source of the search result as the generative model; and/or,
display a preset identifier representing the generative model.

An alternative embodiment further includes a chat processing module 88, configured to:
display a jumping access for the generative model and receive a click-on operation for the jumping access; or, receive a click-on operation for the search result or a click-on operation for the recommended search term;
jump to display a chat page associated with the generative model;
receive a chat content input in the chat page; and
return reply information for the chat content, where the reply information is generated by the generative model.

For the description of the processing flow of each module in the apparatus and the interaction flow between modules, reference can be made to the relevant description in the above method embodiments, and will not be described in detail here.

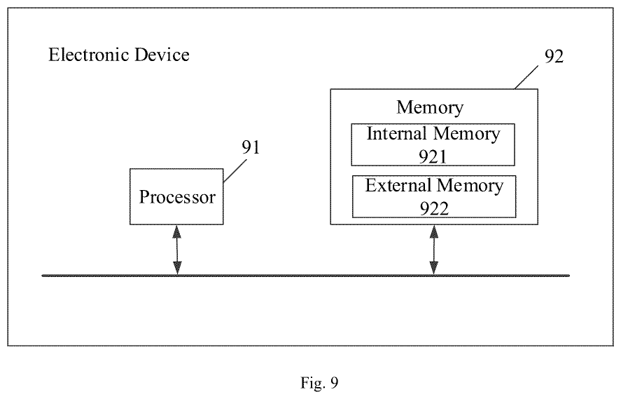

The embodiment of the present disclosure further provides an electronic device. As shown in FIG. 9, which is a schematic structural diagram of the electronic device provided by the embodiment of the present disclosure, including:
a processor 91 and a memory 92; the memory 92 stores machine-readable instructions executable by the processor 91, and the processer 91 is configured to execute the machine-readable instructions stored in the memory 92. When the machine-readable instructions are executed by the processor 91, the processor 91 performs the following steps:
receiving an input search term;
acquiring a search result corresponding to the search term and a display target page of the search result, where the search result is multimedia information which is generated based on a generative model and answers the search term, and the display target page is determined according to at least one attribute characteristic of the search result; and
displaying the search result in the display target page.

In an alternative embodiment, the display target page is determined by the processor 91 through the following steps:
determining the display target page of the search result according to the attribute characteristic corresponding to the search result, where the attribute characteristic includes at least one of the following: a size of a display area as required, a number of the display result, and a type of multimedia content contained in the multimedia information.

In an alternative embodiment, when determining the display target page of the search result according to the attribute characteristic corresponding to the search result, the processor 91 is configured to: determine the display target page of the search result as a search prompt page of the search term in response to a first condition being satisfied, where the search prompt page represents a page containing a prompt box of a search box;
the first condition includes: the size of the display area as required by the search result does not exceed a preset size or a display proportion of the size of the display area as required does not exceed a preset proportion, and the number of the search result is one, where one search result is able to answer the search term, and the one search result includes information that does not exceed a preset number of lines.

In an alternative embodiment, when determining the display target page of the search result according to the attribute characteristic corresponding to the search result, the processor 91 is configured to: determine the display target page of the search result as a search result page of the search term in response to a second condition being satisfied;
the second condition includes at least one of the following: the size of the display area required by the search result exceeds a preset size or a display proportion of the size of the display area as required exceeds a preset proportion, and the number of the search result is greater than one, where at least two search results are required to be able to answer the search term, or the search result that corresponds to the search term and answers the search term includes information exceeding the preset number of lines.

In an alternative embodiment, when displaying the search result in the display target page, the processor 91 is configured to: display the search result in a line-by-line display mode in the form of a display card in the search result page of the search term, where in the line-by-line display mode, a time interval for displaying each line is related to a time for generating each line of information of the search result by the generative model.

In an alternative embodiment, the search result is determined by the processor 91 in the following way:
determining a search intention of the search term;
determining, according to the search intention, a working state of the generative model when generating the search result, where the working state is an offline state or an online state; and
generating the search result corresponding to the search term based on the generative model in the working state.

In an alternative embodiment, when generating the search result corresponding to the search term based on the generative model in the working state, the processor 91 is configured to:
acquire a preset number of top-ranked initial search results which are matching the search term and sorted according to relevant degree, in response to the working state being the online state; and
perform semantic analysis on the preset number of top-ranked initial search results based on the generative model by using the preset number of top-ranked initial search results as input parameters, to acquire the search result corresponding to the search term.

In an alternative embodiment, the processor 91 is further configured to display a recommended search term card in a search interstitial page or a search result page of the search term;
a recommended search term in the recommended search term card is generated based on the generative model according to a preset determinant factor, and the preset determinant factor includes at least one of the following: a historical search behavior, a historical browsing behavior, a quality evaluation degree of the search result corresponding to the recommended search term, and feedback information of a target object.

In an alternative embodiment, the processor 91 is further configured to: receive a drop-down operation for the search interstitial page and display a jumping access for the generative model.

In an alternative embodiment, the processor 91 is further configured to: display a source of the search result as the generative model; and/or, display a preset identifier representing the generative model.

In an alternative embodiment, the processor 91 is further configured to:
display a jumping access for the generative model and receive a click-on operation for the jumping access; or, receive a click-on operation for the search result or a click-on operation for the recommended search term;
jump to display a chat page associated with the generative model;
receive a chat content input in the chat page; and
return reply information for the chat content, where the reply information is generated by the generative model.

The memory 92 includes an internal memory 921 and an external memory 922. The internal memory 921 here is also referred to as an internal storage, which is used to temporarily store the operation data in the processor 91 and the data exchanged with the external memory 922 such as a hard disk. The processor 91 exchanges data with the external memory 922 through the internal memory 921.

The specific execution process of the above-described instructions can refer to the steps of the searching method described in the embodiments of the present disclosure, and will not be repeated here.

The embodiment of the present disclosure further provides a computer-readable storage medium, on which a computer program is stored, and when the computer program is executed by a processor, the steps of the searching method described in the above method embodiments are executed. The storage medium can be a volatile or nonvolatile computer-readable storage medium.

The embodiment of the present disclosure further provides a computer program product, which carries a program code, and the program code includes instructions that can be configured to execute the steps of the searching method described in the above method embodiments. For details, reference can be made to the above method embodiments, which will not be repeated here.

The above-described computer program product can be realized by hardware, software or their combination. In one alternative embodiment, the computer program product is embodied as a computer storage medium, and in another alternative embodiment, the computer program product is embodied as a software product, such as a Software Development Kit (SDK) and the like.

It can be clearly understood by those skilled in the art that for the convenience and conciseness of description, the specific working process of the system and device described above can refer to the corresponding process in the aforementioned method embodiments, and will not be repeated here. In several embodiments provided by the present disclosure, it should be understood that the disclosed systems, devices and methods can be realized in other ways. The device embodiments described above are only schematic. For example, the division of the units is only in terms of logical function, and there may be other division methods in actual implementations. For example, multiple units or components may be combined or integrated into another system, or some of these features may be ignored or not implemented. On the other hand, the mutual coupling or direct coupling or communicative connection as illustrated or discussed can be indirect coupling or communication connection through some communication interfaces, devices or units, which can be in electrical, mechanical or other forms.

The units described as separate components may or may not be physically separated, and the components displayed as units may or may not be physical units, that is, they may be located in one place or distributed to multiple network units. Some or all of these units can be selected to achieve the purpose of this embodiment according to actual needs.

In addition, various functional units in various embodiments of the present disclosure may be integrated into one processing unit, or various may exist physically separately, or two or more units may be integrated into one unit.

If the functions are realized in the form of software functional units and sold or used as independent products, they can be stored in a processor-executable nonvolatile computer-readable storage medium. Based on this understanding, the technical solution of the present disclosure can be embodied in the form of a software product, which is stored in a storage medium and includes several instructions to enable an electronic device (which can be a personal computer, a server, a network device, etc.) to execute all or part of the steps of the method described in various embodiments of the present disclosure. The aforementioned storage medium includes: U disk, mobile hard disk, Read-Only Memory (ROM), Random-Access Memory (RAM), magnetic disk or optical disk and other mediums that can store program codes.

Finally, it should be explained that the above-mentioned embodiments are only specific embodiments of the present disclosure, which are used to illustrate the technical solution of the present disclosure, but not to limit it. The scope of protection of the present disclosure is not limited to this. Although the present disclosure has been described in details with reference to the above-mentioned embodiments, it should be understood by those ordinary skilled in the art that any person familiar with the technical field can still modify or easily conceive of changes to the technical solution recorded in the above-mentioned embodiments within the technical scope of the present disclosure, while these modifications, changes or substitutions do not make the essence of the corresponding technical solution deviate from the spirit and scope of the technical solution of the embodiment of the present disclosure, and should be included in the scope of protection of the present disclosure. Therefore, the scope of protection of the present disclosure should be based on the scope of protection of the appended claims.

1. A searching method, comprising:
receiving an input search term;
acquiring a search result corresponding to the search term and a display target page of the search result, wherein the search result is multimedia information which is generated based on a generative model and answers the search term, and the display target page is determined according to at least one attribute characteristic of the search result; and
displaying the search result in the display target page.

2. The method according to claim 1, wherein the display target page is determined by:
determining the display target page of the search result according to the attribute characteristic corresponding to the search result, wherein the attribute characteristic comprises at least one of: a size of a display area as required, a number of the search result, and a type of multimedia content contained in the multimedia information.

3. The method according to claim 2, wherein determining the display target page of the search result according to the attribute characteristic corresponding to the search result comprises:
determining the display target page of the search result as a search prompt page of the search term in response to a first condition being satisfied, wherein the search prompt page represents a page containing a prompt box of a search box; wherein
the first condition comprises: the size of the display area as required by the search result does not exceed a preset size or a display proportion of the size of the display area as required does not exceed a preset proportion, and the number of the search results is one, wherein one search result is able to answer the search term, and the one search result comprises information which does not exceed a preset number of lines.

4. The method according to claim 2, wherein determining the display target page of the search result according to the attribute characteristic corresponding to the search result comprises:
determining the display target page of the search result as a search result page of the search term in response to a second condition being satisfied; wherein
the second condition comprises at least one of: the size of the display area as required by the search result exceeds a preset size or a display proportion of the size of the display area as required exceeds a preset proportion, and the number of the search result is greater than one, wherein at least two search results are required to be able to answer the search term, or the search result that corresponds to the search term and is able to answer the search term comprises information exceeding a preset number of lines.

5. The method according to claim 4, wherein displaying the search result in the display target page comprises:
displaying the search result in a line-by-line display mode in a form of a display card in the search result page of the search term, wherein
a time interval for displaying each line in the line-by-line display mode is related to a time for generating each line of information of the search result by the generative model.

6. The method according to claim 1, wherein the search result is determined by:
determining a search intention of the search term;
determining, according to the search intention, a working state of the generative model when generating the search result, wherein the working state is an offline state or an online state; and
generating the search result corresponding to the search term based on the generative model in the working state.

7. The method according to claim 6, wherein generating the search result corresponding to the search term based on the generative model in the working state comprises:
acquiring a preset number of top-ranked initial search results which are matching the search term and sorted according to relevant degree, in response to the working state being the online state; and
performing semantic analysis on the preset number of top-ranked initial search results based on the generative model by using the preset number of top-ranked initial search results as input parameters, to acquire the search result corresponding to the search term.

8. The method according to claim 1, further comprising:
displaying a recommended search term card in a search interstitial page or a search result page of the search term; wherein
a recommended search term in the recommended search term card is generated based on the generative model according to a preset determinant factor, and the preset determinant factor comprises at least one of: a historical search behavior, a historical browsing behavior, a quality evaluation degree of the search result corresponding to the recommended search term, and feedback information of a target object.

9. The method according to claim 8, further comprising:
receiving a drop-down operation for the search interstitial page and displaying a jumping access for the generative model.

10. The method according to claim 1, further comprising:
displaying a source of the search result as the generative model; and/or
displaying a preset identifier representing the generative model.

11. The method according to claim 1, further comprising:
displaying a preset floating button, wherein the preset floating button represents a jumping access for the generative model.

12. The method according to claim 1, further comprising:
displaying a jumping access for the generative model and receiving a click-on operation for the jumping access; or, receiving a click-on operation for the search result or a click-on operation for a recommended search term;
jumping to display a chat page associated with the generative model;
receiving a chat content input in the chat page; and
returning reply information for the chat content, wherein the reply information is generated by the generative model.

13. (canceled)

14. An electronic device, comprising a processor and a memory, wherein the memory stores machine-readable instructions executable by the processor, and the processor is configured to execute the machine-readable instructions stored in the memory, and
when the machine-readable instructions are executed by the processor, the processor performs steps of a searching method, comprising:
receiving an input search term;
acquiring a search result corresponding to the search term and a display target page of the search result, wherein the search result is multimedia information which is generated based on a generative model and answers the search term, and the display target page is determined according to at least one attribute characteristic of the search result; and
displaying the search result in the display target page.

15. A computer-readable storage medium having a computer program stored thereon, wherein the computer program, when executed by a processor, realizes steps of a searching method, comprising:
receiving an input search term;
acquiring a search result corresponding to the search term and a display target page of the search result, wherein the search result is multimedia information which is generated based on a generative model and answers the search term, and the display target page is determined according to at least one attribute characteristic of the search result; and
displaying the search result in the display target page.

16. The electronic device according to claim 14, wherein in the searing method, the display target page is determined by:
determining the display target page of the search result according to the attribute characteristic corresponding to the search result, wherein the attribute characteristic comprises at least one of: a size of a display area as required, a number of the search result, and a type of multimedia content contained in the multimedia information.

17. The electronic device according to claim 16, wherein in the searing method, determining the display target page of the search result according to the attribute characteristic corresponding to the search result comprises:
determining the display target page of the search result as a search prompt page of the search term in response to a first condition being satisfied, wherein the search prompt page represents a page containing a prompt box of a search box; wherein
the first condition comprises: the size of the display area as required by the search result does not exceed a preset size or a display proportion of the size of the display area as required does not exceed a preset proportion, and the number of the search results is one, wherein one search result is able to answer the search term, and the one search result comprises information which does not exceed a preset number of lines.

18. The electronic device according to claim 16, wherein in the searing method, determining the display target page of the search result according to the attribute characteristic corresponding to the search result comprises:
determining the display target page of the search result as a search result page of the search term in response to a second condition being satisfied; wherein
the second condition comprises at least one of: the size of the display area as required by the search result exceeds a preset size or a display proportion of the size of the display area as required exceeds a preset proportion, and the number of the search result is greater than one, wherein at least two search results are required to be able to answer the search term, or the search result that corresponds to the search term and is able to answer the search term comprises information exceeding a preset number of lines.

19. The electronic device according to claim 18, wherein in the searing method, displaying the search result in the display target page comprises:
displaying the search result in a line-by-line display mode in a form of a display card in the search result page of the search term, wherein
a time interval for displaying each line in the line-by-line display mode is related to a time for generating each line of information of the search result by the generative model.

20. The electronic device according to claim 14, wherein in the searing method, the search result is determined by:
determining a search intention of the search term;
determining, according to the search intention, a working state of the generative model when generating the search result, wherein the working state is an offline state or an online state; and
generating the search result corresponding to the search term based on the generative model in the working state.

21. The electronic device according to claim 20, wherein in the searing method, generating the search result corresponding to the search term based on the generative model in the working state comprises:
acquiring a preset number of top-ranked initial search results which are matching the search term and sorted according to relevant degree, in response to the working state being the online state; and
performing semantic analysis on the preset number of top-ranked initial search results based on the generative model by using the preset number of top-ranked initial search results as input parameters, to acquire the search result corresponding to the search term.
